(19) United States
(12) Patent Application Publication
(10) Pub. No.: US 2012/0036964 A1
(43) Pub. Date: Feb. 16, 2012

(54) BOTTLE OPENER

(75) Inventor: Martin Bader, Biberwier (AT)

(73) Assignee: ALFRED FRANZ NEUBERGER, EHRWALD (AT)

(21) Appl. No.: 13/259,452

(22) PCT Filed: Mar. 15, 2010
(86) PCT No.: PCT/AT2010/000078

§ 371 Date: Oct. 4, 2011

(30) Foreign Application Priority Data
Mar. 24, 2009 (AT) GM 175/2009

(51) Int. Cl. B67B 7/18

(52) U.S. Cl. 81/3.4

(57) ABSTRACT

Bottle opener for opening a bottle closed with a screw cap, in particular a wine bottle, wherein the bottle opener includes an annular contact element (1) having an inside surface (2) for resting against the screw cap, wthe inside surface (2) delimits a receiving cavity (3) for receiving the screw cap, and the inside surface (2) is delimited by two, preferably circular, edges (4, 4′) of the contact element (1) and the diameter (5) of the receiving cavity (3) delimited by the inside surface (2) decreases at least sectionally, starting from at least one of the edges (4) in the direction toward the other edge (4″), and a counter-clockwise internal thread (6) is formed on the inside surface.

### BACKGROUND

The invention relates to a bottle opener for opening a bottle closed with a screw cap, particularly a wine bottle.

In recent years, more and more wine bottles have entered the market, which are no longer closed with the traditional cork but rather with a screw cap. On the one hand, this is more hygienic, on the other hand, the screw cap guarantees a safe and also long lasting air-tight seal of the wine bottles, which is not always ensured in the traditional cork.

In particularly in restaurants, there is the need for bottle openers, which allow opening wine bottles with a screw cap, or other bottles provided with a screw cap, in an elegant and reliable fashion, requiring as little force as possible.

### SUMMARY

This objective is attained according to the invention in the bottle opener comprising an annular contact element with an inside surface to contact the screw cap, with the inside surface delimiting a receiving cavity to accept the screw cap and the inside surface being delimited by two preferably annular edges of the contact element, and the diameter of the receiving cavity delimited by the inside surface tapering sectionally beginning at least at one of the edges in the direction towards the other edge and the inside surface being embodied as a counter-clockwise internal thread.

A contact element embodied in this fashion allows a reliable and also low-force removal of a screw cap from the bottle, particularly a wine bottle. Here, the bottle opener can be placed onto the screw cap at different angles, without risking that the attempt to open the bottle might fail. The bottle opener according to the invention therefore requires no particularly precise placement of the screw cap. By the combination of the features of a diameter of the inside surface and/or the receiving cavity delimited thereby reducing in one direction with the counter-clockwise thread inserted into the inside surface a high operating comfort is yielded and a secure opening of the bottle.

Upon placement of the bottle opener onto the screw cap, first the internal thread of the bottle opener cuts into the screw cap when the operator begins to turn the bottle opener in the normal opening direction of a screw cap. This way, after a relatively small rotational angle a good lasting connection is produced between the bottle opener and the screw cap. When the bottle opener is then simply turned further in the same direction, the screw cap is screwed off the bottle. The fastening of the bottle opener to the screw cap as well as the unscrewing of the screw cap therefore occur both in the same direction of rotation, allowing a reliable and quick opening of the bottle. Even when such bottle openers, particularly in restaurants, are primarily intended for opening wine bottle, of course any other bottle comprising a screw cap can also be opened therewith in a simple and quick fashion.

Beneficial embodiments of the invention provide that the top of the internal threads of the inside surface are located on a rotation-symmetrical surface and/or that the roots of the internal threads of the inside surface are located on a rotation-symmetrical surface. In particular, it may be provided here that the top of the internal threads of the inside surface are located on a frustum surface and/or that the roots of the internal threads of the inside surface are located on a frustum surface. Extensive experiments have shown that it is beneficial for the internal thread to have a thread pitch and/or a so-called lead ranging from 0.1 mm/rotation to 0.4 mm/rotation, preferably from 0.2 mm/rotation to 0.27 mm/rotation. The thread depth, i.e. the depth of a convolution of the internal thread should beneficially range from 0.01 mm to 0.5 mm, preferably from 0.15 mm to 0.25 mm. During the tests performed it has shown that in case of deviations from the above-mentioned values either no reliable connection developed between the screw top and the bottle opener or the screw top was deformed by the internal thread to such an extent that an unscrewing of the screw top was hindered.

In order for the internal thread to reliably cut into the screw top it is beneficial for the threads tops to be embodied with an acutely angled cross-section. The roots of the threads however may have a rounded cross-section.

Beneficially the annular contact element is formed from metal, at least in the area of the inside surface and the internal thread, but preferably in its entirety. For the production of the contact element the use of steel is particularly beneficial and here especially stainless steel.

In order to prevent the contact element and/or the bottle opener from being accidentally placed in the wrong manner onto the screw cap to be opened, preferred embodiments of the invention provide that the diameter of the receiving cavity, delimited by the inside surface, at least partially tapers beginning at each of the edges in the direction to the respectively other edge. Such variants may be embodied essentially symmetrical in reference to a central level, at least concerning the progression of the diameter of the inside surface and/or the receiving cavity. In such embodiments it is beneficially provided that a minimal diameter of the receiving cavity, limited by the inside surface, is located in the middle between the edges. Particularly for screw caps common for wine bottles it is beneficial for the diameter of the receiving cavity, delimited by the inside surfaces, to amount to a value ranging from 30 mm to 30.5 mm at one edge, preferably at both edges of the contact element. The minimal diameter of the receiving cavity delimited by the inside surface ranges in preferred embodiments of the invention from 28 mm to 29 mm.

### BRIEF DESCRIPTION OF THE DRAWINGS

Additional features and details of preferred embodiments of the invention are explained using the description of the figures. Shown here are:

FIG. 1 an exemplary embodiment of a bottle opener according to the invention,

FIG. 2 a top view from the direction of the longitudinal central axis of the annular contact element of said bottle opener,

FIG. 3 the detail A of FIG. 2,

FIG. 4 a longitudinal cross-section through the annular contact element of the bottle opener according to FIG. 1,

FIG. 5 an alternative embodiment of an annular contact element, and

FIG. 6 the detailed views B of FIGS. 4 and 5.

### DETAILED DESCRIPTION OF THE PREFERRED EMBODIMENTS

FIG. 1 shows a perspective view of a bottle opener embodied according to the invention. The contact element 1 is here made from stainless steel, in the present case arranged centrally in a handle part 20. In the exemplary embodiment shown the handle part 20 is embodied disk-shaped, at least sectionally, and may e.g. be made from wood. Of course, this is only an example. The essential technical effect of the handle part 20 is the increase of the torque by enlarging the distance of the part of the bottle opener, at which it is grasped, from the longitudinal axis 17. For reasons of completeness it shall be pointed out that the handle part 20 may also have any other suitable shape. In the exemplary embodiment shown, a recess 21 is provided at the exterior edge of the handle part 20. This allows placing the bottle opener standing on its edge in the area of said recess 21.

The annular contact element 1 embodied according to the invention is arranged in a central recess of the handle part 20 of the bottle opener shown. It encompasses with its inside surface 2 the receiving cavity 3, into which the screw cap to be removed, particularly from a wine bottle, can be inserted. According to the invention the inside surface 2 comprises, as shown according to the following figures, a diameter 5 sectionally tapering from one edge 4 of the contact element 1 in the direction towards the other edge 4′. Additionally, at the inside surface a counter-clockwise internal thread 6 is formed, i.e. an internal thread 6 threaded counter-clockwise. The depth of the thread 10 and the pitch 9 are embodied so small, however, that the internal thread 6 is only discernible in a detailed view.

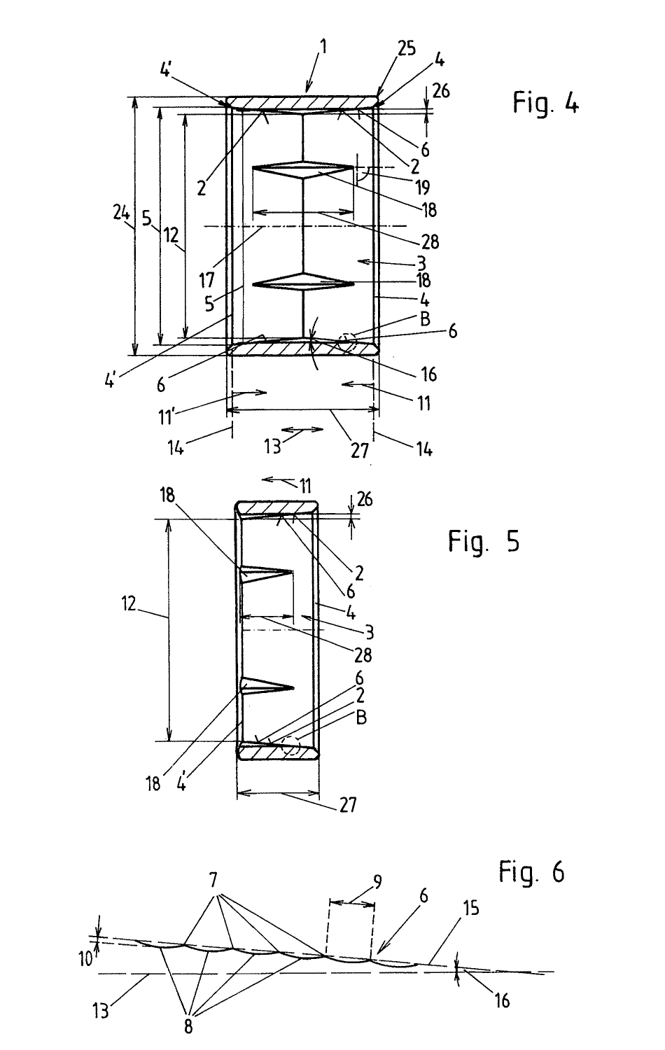

Optionally, as in the exemplary embodiment shown according to FIG. 1, notches 18 may be arranged in the inside surface 2. They beneficially extend essentially parallel to the longitudinal central axis 17 and thus at an angle 19 ranging from 80° to 100°, preferably from 87° to 93°, in reference to the thread tops 7 and/or thread roots 8 of the internal thread 6, as particularly indicated in FIG. 4. The edges in the inside surface 2 caused by the notches further facilitate the cutting of the internal thread 6 into the screw cap. As already stated, the notches 18 may be omitted, though.

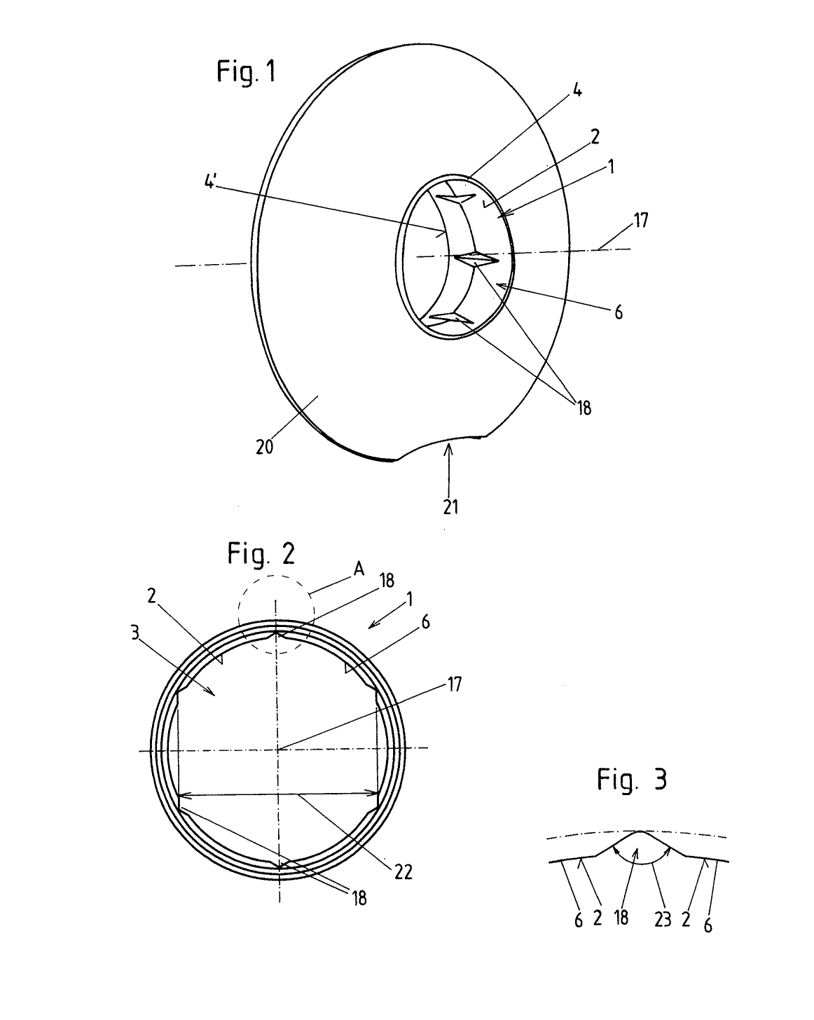

FIG. 2 shows a top view of the annular contact element 1 from the direction of the longitudinal central axis 17. Here, the notches 18 are shown particularly well. In the exemplary embodiment shown they are arranged in a regular hexagon. However, this is not mandatory, of course. In the exemplary embodiment shown, the width 22 is 25.82 mm. FIG. 3 shows the detail A from FIG. 2. The opening angle 23 of the notch 18 shown in detail, is similar to the other notches 18 shown in FIG. 2, and is 120°. Of course, this is only exemplary.

FIG. 4 shows a longitudinal cross-section through the contact element 1 of the first exemplary embodiment. This longitudinal cross-section extends on the one side along and/or parallel to the longitudinal central axis 17 of the contact element 1, on the other side this longitudinal cross-section extends in the exemplary embodiment shown also parallel and/or along a direction 13, which extends normally to a plane 14 stretched between the edges 4 and 4′ of the contact element 1.

In FIG. 4 it is shown particularly well how the diameter 5 of the receiving cavity 3, starting at the edge 4, tapers in the direction 11 towards the other edge 4′ within a first section. This first section ends at the minimal diameter 12, which in the exemplary embodiment shown here, seen along the longitudinal central axis 17, is located in the center between the edges 4 and 4′. Coming from the other side, i.e. starting at the edge 4′, the diameter 5 of the receiving cavity 3 tapers equally, but in the opposite direction, namely towards the other edge 4. This section, beginning at the edge 4′, also ends at the centrally arranged minimal diameter 12. In the exemplary embodiment shown the minimal diameter 12 is 28.5 mm, the diameter 5 in the area of the edges is 30.3 mm. The contact element 1 of this exemplary embodiment further comprises an exterior diameter 24 of 33 mm. The overall width 27 of the exemplary embodiment is 20 mm, measured parallel in reference to the longitudinal central axis 18 and/or the normal 13. Half of the maximum difference of the diameter 26 amounts to 0.6 mm. The width 28 of the notches 18, again in the direction parallel in reference to the longitudinal central axis 17 and/or the normal 13, amounts to 13.33 mm. Shown particularly in FIG. 6, the angle 16 between a straight line 15 through the thread tops 7 of the internal thread 6 and the longitudinal central axis 17 and/or the normal 13 is 14° in the illustrated exemplary embodiment 5. Tests have shown that this angle 16 should range at least from 1° to 10°, preferably from 3° to 7°. The internal thread 6 arranged and/or formed at the inside surfaces 2 is not discernible in the illustration according to FIG. 4. Here, reference is made to the detail B, as shown enlarged in FIG. 6. FIG. 6 shows the internal thread 6 of the exemplary embodiment shown, arranged at the inside surface 2 encircling the longitudinal central axis 17, at a scale of 50:1. This illustrates that it represents a thread with a very low pitch 9 and also very low thread depth 10. In the exemplary embodiment shown the pitch 9 and/or the height of the thread only amounts to 0.24 mm/rotation, with the pitch 9, as generally known, being calculated from the distance of two adjacent thread tops 7. The depth of the thread 10, which states the difference in height in the direction towards a normal on the straight line 15 between the top of the thread 7 and an adjacent base of the thread 8, amounts to only 0.2 mm in the exemplary embodiment shown. The pitch 9 and depth of the thread 10 may however be varied within the value range stated at the outset. Additionally, in FIG. 6 it is shown particularly well that the thread tops 7 are embodied with an acute angle in the cross-section shown, while the roots of the threads may also be embodied rounded. In any case, by the acutely angled thread tops 7 the cutting of the internal thread 6 into the screw cap to be removed from a bottle is facilitated. Of course, the thread roots 8 and the thread tops 7 may also have different forms. The cutting of the respective internal thread 6 into the inside surface 2 can be performed by cutting methods known from prior art.

The exemplary embodiment of an annular contact element 1 according to FIG. 4 is advantageous, as explained at the outset, in that the screw cap to be removed from the bottle can be inserted into the receiving cavity 3 from both the direction 11 as well as the direction 11′. The operator is therefore not required to pay attention to place the bottle opener correctly onto the screw cap. Although it is surely beneficial in the sense of a practical handling, such a symmetrical design of the annular contact element is not mandatory. Accordingly, FIG. 5 shows an exemplary embodiment, otherwise embodied like in FIG. 4, in which the diameter of the receiving cavity 3 tapers exclusively from the edge 4 in the direction 11 towards the other edge 4′. This allows a flatter design of the contact element and thus the bottle opener, however it is disadvantageous here in that the screw cap to be removed must always be inserted from the direction 11 into the receiving cavity 3. The overall width 27 of this exemplary embodiment amounts to only 1 cm. The width 28 of the notches 18 amounts to approx. 6.6 mm. The other dimensions are consistent with those of the exemplary embodiment according to FIG. 4, and here it is pointed out once more that this is only one of many potential examples, of course.

For reasons of completeness, finally it is also pointed out that in the exemplary embodiments shown the thread tops 7 of the respective internal thread are each located on a frustum surface, as are the thread roots 8. In the exemplary embodiments shown the rotational axis of these frustum surfaces coincides with the longitudinal central axis 17. Deviating from this conical embodiment there are other potential embodiments, in which the thread tops 7 and/or the thread roots 8 are located on a rotationally symmetrical surface, which not mandatorily represents a frustum surface.

### LEGEND OF THE REFERENCE CHARACTERS

1 Contact element
2 Inside surface
3 Receiving cavity
4, 4′ Edge
5 Diameter
6 Internal thread
7 Thread Top
8 Thread Root
9 Pitch
10 Depth of the tread
11, 11′ Direction
12 Minimum diameter
13 Direction
14 Level
15 Straight line
16 Angle
17 Longitudinal central axis
18 Notch
19 Angle
20 Handle part
21 Recess
22 Width
23 Opening angle
24 Exterior diameter
25 Rounded exterior edge
26 Half of maximum diameter difference
27 Overall width
28 Width

1. A bottle opener for opening a bottle closed with a screw cap, comprising an annular contact element (1) with an inside surface (2) adapted to contact the screw cap, with the inside surface (2) delimiting a receiving cavity (3) to accept the screw cap and the inside surface (2) being limited by two edges (4, 4′) of the contact element (1) and a diameter (5) of the receiving cavity (3), limited by the inside surface (2), beginning at least at one of the edges (4) tapers in a direction towards the other edge (4′), at least sectionally, and the inside surface is formed with a counter-clockwise internal thread (6).

2. The bottle opener according to claim 1, wherein thread tops (7) of the internal thread (6) of the inside surface (2) are located on a rotationally symmetrical surface and/or thread roots (8) of the internal thread (6) of the inside surface (2) are located on a rotationally symmetrical surface.

3. The bottle opener according to claim 2, wherein at least one of the thread tops (7) of the internal thread (6) of the inside surface (2) are located on a frustum surface or the thread roots (8) of the internal thread (6) of the inside surface (2) are located on a frustum surface.

4. The bottle opener according to claim 1, wherein the internal thread (6) comprises a pitch (9) ranging from 0.1 mm/rotation to 0.4 mm/rotation.

5. The bottle opener according to claim 1, wherein the internal thread (6) comprises a depth of the thread (10) ranging from 0.01 mm to 0.5 mm.

6. The bottle opener according to claim 1, wherein the internal threads (6) comprise thread tops (7) having an acutely angled cross-section.

7. The bottle opener according to claim 1, wherein the internal thread (6) comprises thread roots (8) having a rounded cross-section.

8. The bottle opener according to claim 1, wherein the diameter (5) of the receiving cavity (3) delimited by the inside surface (2), beginning at each of the edges (4, 4′), tapers towards the respectively other edge (4, 4′), at least sectionally, in a direction (11, 11′) towards the respectively other edge (4, 4′).

9. The bottle opener according to claim 8, wherein a minimal diameter (12) of the receiving cavity (3) delimited by the inside surface (2) is located in a middle between the edges (4, 4′).

10. The bottle opener according to claim 1, wherein the diameter (5) of the receiving cavity (3) delimited by the inside surface (2) ranges at least one of the edges (4, 4′) from 30 mm to 30.5 mm.

11. The bottle opener according to claim 1, wherein a minimum diameter of the receiving cavity (3) delimited by the inside surface (2) ranges from 28 mm to 29 mm.

12. The bottle opener according claim 1, wherein, seen in a longitudinal cross-section through the contact element (1), in a direction (13) normal to a plane (14) defined by one of the edges (4, 4′), a straight line (15) extends through thread tops (7) of the internal thread (6) with the direction (13) being normal in reference to the plane (14) forming an angle (16) from 1° to 10°.

13. The bottle opener according to claim 1, wherein, seen in a longitudinal cross-section through the contact element (1), which extends along a longitudinal central axis (17) of the contact element (1), a straight line (15) extends through thread tops (7) of the internal thread (6), forming with the longitudinal central axis (17) an angle (16) ranging from 1° to 10°.

14. The bottle opener according to claim 2, wherein at least one notch (18) is arranged in the inside surface (2), with which the thread tops (7) of the inside surface (6) form an angle (19) from 80° to 100 °.

15. The bottle opener according to claim 1, wherein the contact element (1) is arranged in or at one handle part (20).
